(19) United States
(12) Patent Application Publication
(10) Pub. No.: US 2014/0265088 A1
(43) Pub. Date: Sep. 18, 2014

(54) CUTTING BOARD

(71) Applicant: Thomas Dean Arvan, Franklin, OH (US)

(72) Inventor: Thomas Dean Arvan, Franklin, OH (US)

(21) Appl. No.: 13/826,444

(22) Filed: Mar. 14, 2013

(51) Int. Cl. A47J 47/00

(52) U.S. Cl. CPC A47J 47/005
USPC 269/14

(57) ABSTRACT

A cutting board according to various embodiments of this invention includes a body having top and bottom surfaces, first and second ends, and first and second sides with the top surface being a cutting surface adapted to have a food item such as a piece of meat placed thereon for cutting, slicing or carving. The cutting board may have a plurality of channels recessed in the top surface of the body with each of the channels having a variable-depth and being positioned perpendicular to and between the first and second ends of the cutting board. The variable-depth of each of the channels may increase between the first end and the second end of the body. A reservoir may be included proximate the second end of the body and in fluid communication with each of the channels.

### TECHNICAL FIELD

The present invention relates generally to cutting boards, and more specifically, to cutting boards which provide a manner of collecting juices from foods cut thereon.

### BACKGROUND OF THE INVENTION

When slicing, cutting or carving food items such as meat on a cutting board, juices typically emanate from the meat or other food item and may create puddles on the cutting board. Juices collecting on the surface of the cutting board may hinder the carving process, runoff of the board and create a mess, or lead to the loss of juices from the meat that otherwise would be utilized for other purposes, such as making a gravy. Known cutting boards may include features that are intended to control the juices. However, such prior art cutting boards do not provide for channeling and collecting the juices in a defined location on the cutting board and which may also remove the juices from the cutting surface. Moreover, prior art cutting boards do not provide a way of efficient and effective transfer of the collected juices for disposal or subsequent use.

There is therefore a need in the art for a cutting board which does not hinder the carving process, inhibits messes from occurring as a result of the carving process, and provides for efficient and effective transfer of collected juices for disposal or subsequent use.

### SUMMARY OF THE INVENTION

These and other objectives of the invention have been attained by a cutting board according to various embodiments of this invention. In one embodiment, the cutting board of this invention includes a body having top and bottom surfaces, first and second ends, and first and second sides with the top surface being a cutting surface adapted to have a food item such as a piece of meat placed thereon for cutting, slicing or carving. The cutting board may have a plurality of channels recessed in the top surface of the body with each of the channels having a variable-depth and being positioned perpendicular to and between the first and second ends of the cutting board. The variable-depth of each of the channels may increase between the first end and the second end of the body. A reservoir may be included proximate the second end of the body and in fluid communication with each of the channels such that the reservoir is in fluid communication with the channels at a point where the depth of the channels is greatest relative to the top surface. A spout may extend from a bottom portion of the reservoir to a perimeter of the body and be situated transversely to at least one of the first and second sides and the first and second ends of the body to allow for a user to pour the collected juices from the reservoir of the cutting board. The cutting board may include a handle spaced from the reservoir and the spout to facilitate manipulation of the cutting board by a user. Moreover, the cutting board may include a secondary channel spaced from the reservoir and in fluid communication with each of the plurality of channels to assist in the collection and flow of the juices from the food item being cut on the cutting board to the reservoir.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows a perspective view of one embodiment of a cutting board according to this invention showing juices flowing into a reservoir;

FIG. 2 shows a perspective view of the cutting board of FIG. 1;

FIG. 3 shows a top view of the cutting board of FIG. 1;

FIG. 4 shows a side cross-sectional view of the cutting board of FIG. 1 along line 4-4 of FIG. 3;

FIG. 5 shows a front cross-sectional view of the cutting board of FIG. 1 along line 5-5 of FIG. 3, and in a tilted position showing juices flowing from a spout;

FIG. 6 shows a top view of an alternative embodiment of a cutting board according to this invention;

FIG. 7 shows a cross-sectional view taken along line 7-7 of FIG. 6 with the cutting board in a tilted position showing juices flowing from the spout.

### DETAILED DESCRIPTION OF THE INVENTION

One embodiment of a cutting board 10 according to this invention is shown in FIGS. 1 through 5. The cutting board 10 includes a body 12, which is defined by first and second ends 14, 16, first and second sides 18, 20, and top and bottom surfaces 22, 24, where the top surface 22 is a cutting surface. The body 12 has a perimeter and as shown is a generally rectangular shape. However, in other embodiments, the body 12 may comprise shapes other than rectangles, such as circles (FIG. 6) or other shapes.

A plurality of channels 25 traverse the body 12 and in one embodiment extend between the first and second ends 14, 16. The channels 25 are each generally linear, traverse the body 12 in a direction generally transverse to the first and second ends 14, 16 are spaced from and generally parallel to each other, and are generally parallel to the first and second sides 18, 20 in the embodiment of FIGS. 1-5. The channels 25 are defined as being a recess in the top surface 22 and extending therefrom to a bottom portion 27 of each channel 25. Each of the channels 25 is further defined as extending from a first, shallow end 26a to a second, deep end 26b, as explained further below, which second ends 26b terminate into a reservoir 32 for collecting juice 30 from a food product, such as meat 28, being sliced on the cutting board 10 over the channels 25.

With reference to FIG. 4, each channel 25 includes a depth that increases from the first, shallow end 26a of the channel 25, having a depth D₁, to the second, deep end 26b of the channel 25 having a depth D₂. As shown, the depth increases constantly between the first, shallow end 26a and second, deep end 26b of the channel 25 in the embodiment of FIGS. 1-5. The elongate bottom portion 27 of each channel 25 is thereby situated at an angle α with respect to the top surface 22. In other embodiments, the increase in depth between the shallow and deep ends 26a, 26b of the channels 25 may be variable instead of constant. Moreover, each of the channels 25 of the embodiment of FIGS. 1-5 is exposed over its entire length to the top cutting surface 22 while in other embodiments according to this invention less than the entire channel may be exposed to the top cutting surface 22. As the meat 28 is cut, juices 30 enter the channels 25 and will traverse to and be collected in the reservoir 32 due to the force of gravity and the configuration of the channels 25.

In one embodiment, an optional secondary channel 34 is provided at or adjacent the shallow end 26a of the channels 25. The secondary channel 34 is generally transverse to the channels 25, and also parallel to the first and second ends 14, 16 and transverse to the first and second sides 18, 20. The secondary channel 34 provides fluid communication between each of the channels 25. Cutting board 10 may also include an aperture 31 adjacent the secondary channel 34 towards the first end 14, which, in conjunction with a portion of the first end 14, provides a handle 33 for a user to carry or manipulate the cutting board 10.

The reservoir 32 is positioned at the second end 16 of the body 12, opposite the handle 33 in the embodiment of FIGS. 1-5. The reservoir 32 is defined as a recess in the body 12 and includes a bottom portion 36. The reservoir 32 is also defined as being between a plurality of walls 38 and the bottom portion 36. The reservoir 32 is in fluid communication with each of the channels 25 such that the channels 25 terminate at the reservoir 32. More specifically, the deep end 26b of each channel 25 is in fluid communication with the reservoir 32. As shown in FIG. 1, the cutting and manipulation of the food item, such as the piece of meat 28, may cause juices 30 to emanate therefrom, and the reservoir 32 is therefore configured to collect juices from the food item being sliced on the cutting board 10 via the channels 25. However, it will be appreciated by those skilled in the art that the disclosure herein is applicable for use with a wide range of food products, whether or not juices 30 or other fluids emanate from those food products when cut or manipulated. Furthermore, those of ordinary skill in the art will recognize that the descriptive terms such as top, bottom, side, and end used herein may not directly apply when there is a change in a frame of reference and are not intended to limit the invention to a particular application, orientation or embodiment.

The reservoir 32 as disclosed and shown herein may be an optional feature of the cutting board 10, 50 (FIGS. 6 and 7) in other, alternative embodiments. For example, the cutting board 10, 50 could be placed next to a sink or other receptacle (such as a non-integral reservoir or bowl) configured to receive juices 30 traversing the channels 25. More specifically, the second end 26b of the channels 25 may be placed adjacent to a sink (where saving the juices 30 is not desired) or other receptacle such that juices 30 exiting flow or drip from the cutting board and into the sink or other receptacle.

In one embodiment, a pair of opposing spouts 40 is provided at the first and second sides 18, 20 of the body 12. More specifically, each spout 40 extends from a side of the reservoir 32 towards the perimeter of the body 12. Even more specifically, each spout 40 has an inner portion 42, an outer portion 44 and a tapered portion 46 therebetween. The inner portion 42 communicates with the reservoir 32 such that the depth of the spout 40 at the inner portion 42 is the same or substantially similar as the depth of the reservoir 32. The outer portion 44 resides at the side 18, 20 of the cutting board 10 to permit collected juices 30 to be poured from the cutting board 10.

The tapered portion 46 extends between the inner portion 42 and the outer portion 44 such that the depth of the spout 40 decreases toward the outer portion 44 to facilitate pouring. Each spout 40 is also defined by walls 48 at each end of thereof which may be parallel to the first and second ends 14, 16 and generally transverse to the first and second sides 18, 20. However, in other embodiments, the walls 48 and thus the spout 40 may be oriented in a different manner or have a different configuration to allow for an advantageous manner of pouring collected juices 30 from the spout 40. For example, the walls 48 may taper inward from the inner portion 42 to the outer portion 44 to provide a thinner, more precise stream of juice 30 as it is being poured. In another example, a spout 40 may be provided at the end 16 of the cutting board 10, or in a corner of the cutting board 10, where a side 18, 20 meets the end 16, in addition to or as an alternative to the spouts 40 in the sides 18, 20. Any number of spouts may be provided including one spout, two spouts, three spouts, etc., as will be deemed convenient such that the invention is not limited to the pair of spouts 40 shown. Spouts 40 are configured such that a user may pour the juices 30 which have collected into the reservoir 32 in a controlled manner (i.e., FIGS. 5 and 7). To assist the user in a controlled pouring of juices 30, the handle 33 may be utilized by a user in tilting the cutting board 10.

An alternative embodiment of a cutting board 50 is shown in FIGS. 6 and 7. Much of the structure and function of the cutting board 50 is identical or substantially similar to the embodiment shown in FIGS. 1 through 5. The identical or substantially similar components have been marked with the same reference numbers without extensive further discussion below. The body 12 is a generally circular shape such that the dimensions thereof may be defined by a radius. More specifically, the body 12 of cutting board 50 is defined by a circumferential edge 52 and top and bottom surfaces 22 and 24. The reservoir 32 is defined by bottom portion 36 and walls 38, and is further defined generally as a shape of a sector of a circle. Spout 40 extends from reservoir 32 to the circumferential edge 52. In this embodiment, the walls 48 of the spouts 40 are shown to taper inwardly, from the reservoir 32 to the circumferential edge 52, but any configuration may be used to facilitate pouring collected juices from the reservoir 32. Thus, as disclosed above, the configuration of optional spout 40 is not limited to the configurations shown in FIGS. 1 through 5 and 6 through 7.

Secondary channel 26, which is optional, is shown as being positioned generally concentrically to the circumferential edge 52. In other embodiments, however, the secondary channel 34 may be positioned differently relative to the channels 25 and the circumferential edge 52. For example, the secondary channel 34 may be linear (i.e., FIG. 1) such that the secondary channel 25 is perpendicular to channels 25. Multiple optional handles 33 are provided in the embodiment shown in FIG. 6, specifically, a pair of opposing handles 33, which may be used to pick up the cutting board 10 with both hands and tilt it downwardly toward spout 40 to pour off collected juices. However, alternative embodiments of the body 12 may include less handles 33, such as zero or one, or more handles 33, such as three, four, etc. And the handles may be positioned at any location on the cutting board 10 that facilitates carrying the board 10, washing the board, or pouring juices from the reservoir 32 of the board 10.

The embodiments shown in FIGS. 1 through 7 include a plurality of essentially linear channels 25. However, it is anticipated that the channels 25 may traverse the body from the first, shallow end 26a to the second, deep end 26b in a configuration other than linear. For example, the channels 25 may include portions which are essentially curvilinear, or in another configuration which includes a first, shallow end 26a and a second, deep end 26b. Configurations of the channels 25 described herein are not meant to limit the configuration of the channels 25 and it is anticipated that alternative embodiments are possible.

Moreover, the amount of channels 25 may be different than the amount shown in FIGS. 1 through 7. For example, there may be one, two, three, or five or more channels 25 traversing the body 12. In one alternative embodiment, for example, there may be one channel 25 having a generally parabolic shape where the first, shallow end 26a is positioned at the vertex of the generally parabolic shape. In that embodiment, there may be multiple second, ends 26b on the chord portions of the generally parabolic shape which may terminate at the reservoir 32.

The body 12 may comprise a variety of materials and be fabricated by a variety of methods of manufacture. For example, the body 12 may comprise wood and may be machined to conform to the configuration of the embodiments as described herein. Alternately, the body 12 may comprise a machined thermoset or thermoplastic polymeric material. Further alternatively, the body 12 may be made from a molding process, such as injection molding of a thermoplastic material. The disclosure, however, is not limited to such materials and methods of manufacture and the selection thereof will be apparent to one skilled in the art.

While the present invention has been illustrated by a description of various exemplary embodiments and while these embodiments have been described in some detail, it is not intended to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with exemplary methods of practicing the present invention as currently known. However, the invention itself should only be defined by the appended claims.

What is claimed is:

1. A cutting board, comprising:
a body having a top cutting surface and a bottom surface; and
a variable-depth channel recessed into the body and in fluid communication with the top cutting surface and having a shallow portion and a deep portion, the deep portion being deeper than the shallow portion;
wherein the variable-depth channel is configured to facilitate flow of a liquid from the shallow portion to the deep portion.

2. The cutting board of claim 1, further comprising:
a reservoir in fluid communication with the deep portion for collecting flow of the liquid.

3. The cutting board of claim 1, wherein:
the channel further comprises a bottom portion, wherein at least part of the bottom portion diverges relative to at least a part of one of the top and bottom surfaces.

4. The cutting board of claim 1, wherein a depth of the variable-depth channel increases constantly from the shallow portion to the deep portion.

5. The cutting board of claim 1, further comprising:
a secondary channel positioned transverse to the variable-depth channel and in fluid communication with the variable-depth channel.

6. The cutting board of claim 1, further comprising a handle.

7. The cutting board of claim 2, further comprising:
a spout in fluid communication with the reservoir to facilitate pouring the liquid from the cutting board.

8. The cutting board of claim 7, further comprising a pair of the spouts on opposing sides of the reservoir.

9. The cutting board of claim 3, wherein the body is further defined by first and second ends, wherein the variable-depth channel is oriented perpendicularly to the first and second ends.

10. The cutting board of claim 7, wherein the reservoir includes a bottom portion, the spout extending from the bottom portion of the reservoir to the perimeter of the body.

11. The cutting board of claim 9, wherein the body is further defined by first and second sides between the first and second ends, and the variable-depth channel is generally parallel to the first and second sides.

12. The cutting board of claim 11, further comprising:
a reservoir adjacent the second end and in fluid communication with the deep portion; and
a spout in fluid communication with the reservoir to facilitate pouring the liquid from the cutting board.

13. The cutting board of claim 12 further comprising a handle formed at the first end.

14. The cutting board of claim 1 wherein an entire length of the variable-depth channel is exposed to the top cutting surface.

15. The cutting board of claim 1 further comprising a plurality of the variable-depth channels.

16. The cutting board of claim 1 wherein the variable-depth channel is generally linear.

17. The cutting board of claim 15 wherein the plurality of variable-depth channels are each spaced from one another and generally parallel to one another.

18. A cutting board, comprising:
a body defined by top and bottom surfaces, first and second ends, and first and second sides wherein the top surface is a cutting surface;
a plurality of channels recessed in the top surface of the body, each of the channels having a variable-depth and being positioned perpendicular to and between the first and second ends, wherein the variable-depth of each of the channels increases between the first end and the second end;
a reservoir proximate the second end of the body and in fluid communication with each of the channels such that the reservoir is in fluid communication with the channels at a point where the depth of the channels is greatest relative to the top surface; and
a spout extending from a bottom portion of the reservoir to a perimeter of the body and situated transversely to at least one of the first and second sides and the first and second ends.

19. The cutting board of claim 18 further comprising:
a handle spaced from the reservoir and the spout.

20. The cutting board of claim 19 further comprising:
a secondary channel spaced from the reservoir and in fluid communication with each of the plurality of channels.
